(19) United States
(12) Patent Application Publication
(10) Pub. No.: US 2012/0130907 A1
(43) Pub. Date: May 24, 2012

(54) PROJECT MANAGEMENT SYSTEM AND METHOD

(75) Inventors: John L. Thompson, Lafayette, LA (US); Daniel P. Walsh, Rancho Santa Fe, CA (US)

(73) Assignee: Execution Software, LLC, Lafayette, LA (US)

(21) Appl. No.: 13/303,039

(22) Filed: Nov. 22, 2011

Related U.S. Application Data
(60) Provisional application No. 61/416,030, filed on Nov. 22, 2010.

(51) Int. Cl. G06Q 10/06

(52) U.S. Cl. 705/301

(57) ABSTRACT

A project management system includes graphical user interfaces for creating, and tracking projects. Status dashboards for both projects and project portfolios allow a user to quickly view the status of their projects and determine which projects are at risk. An algorithm for determining a risk quotient is described for determining risk status of projects. A PERT chart includes status buffers to better understand what projects are at risk.

### CROSS-REFERENCE TO RELATED APPLICATIONS

This application claims priority under 35 U.S.C. §119 to provisional application Ser. No. 61/416,030 filed Nov. 22, 2011, herein incorporated by reference in its entirety.

### FIELD OF THE INVENTION

This invention relates generally to tools and systems for managing projects.

### BACKGROUND OF TILE INVENTION

There are many existing tools that can be used to help manage projects. Most of these are software products that utilizes either Gantt chart or PERT (project evaluation and review technique) chart based systems. A Gantt chart is a type of bar chart that graphically displays the start and finish dates for various tasks within a project. Typically each task is assigned its own bar, and the bar is placed on the chart to span between the planned start and finish dates. The bars may be color coded to illustrate what percent of the task has been completed. A PERT chart utilizes a network structure to illustrate the sequence and interdependence of various tasks within a project.

A concept commonly used in association with existing project management tools is a critical path. A critical path is the longest path of planned activities to the end of the project, and the earliest and latest that each activity can start and finish without making the project longer. This process determines which activities are “critical” (i.e., on the longest path) and which cannot be delayed without making the project longer. In project management, a critical path is the sequence of project network activities which add up to the longest overall duration. This determines the shortest time possible to complete the project. Any delay of an activity on the critical path directly impacts the planned project completion date (re, there is no float on the critical path). A related, and more recent, concept is a critical chain analysis. A critical chain analysis takes into account resource availability in determining a critical chain of activities to complete a project.

However, current project management software tools typically present the information via complex difficult to read charts that often does not include all of the information that would be most helpful to a project manager. Furthermore, they often base their critical chain and critical path by selecting the most loaded resource in a pool of shared resources as part of the critical path. This guarantees that any variation in the loaded resources performance will affect, and most likely delay, the entire portfolio of projects sharing this resource.

Furthermore, existing project management tools lack intuitive and easy to use interfaces for creating and modifying projects and for displaying information about projects or portfolios of projects.

### BRIEF SUMMARY OF THE INVENTION

According to one embodiment, the present invention is directed to a project management system that includes a remote server programmed to generate a graphic user interface that can be accessed by remote user devices. The graphic user interface includes project and portfolio dashboards for quick status display. A portfolio and project status graphic includes a quick view of percentage completed and status category of one or more projects, A portfolio early warning graphic provides a graphical indicator of whether projects are at risk for violating the critical chain.

According to another embodiment the present invention is directed to a project management tool for creating projects. Several remote users can interact simultaneously within a single graphical user interface to create a project. A task creation field is provided. Dialog boxes represent the tasks and. prompt input of necessary information to create tasks. The boxes can be graphically moved around on the field. Dependencies between tasks can be created. by graphically drawing arrows between the task boxes. The boxes may be color coded. A “what if” mode is provided to show what would happen if the status of a task is changed. A status bar may be associated with each task box.

According to another embodiment, the present invention is directed to a computer system that is programmed to determine a dynamic drum resource. The computer system is programmed to determine each of a plurality of resources' loading across a portfolio of projects. Any resource with a utilization of greater than X% (e.g., 90%) cannot be selected as the dynamic drum resource. A first subset of the resources common to a preset percentage of the projects in the portfolio is determined. From the first subset, a second subset of resources is selected that is used over a duration greater than a specified minimum percentage duration of each project from the first subset. For each of the resources in the second subset calculate a total duration of the portfolio of projects if such resource is the dynamic drum resource. The standard deviation of the maximum resource utilization throughout the entire duration of the portfolio of projects is calculated and stored. Select as the dynamic drum resource the resource that had the shortest calculated total duration that also had a calculated standard deviation of less than 1.5.

### BRIEF DESCRIPTION OF THE DRAWINGS

FIG. 1 is a schematic illustrating a project management system according to one embodiment of the present invention.

FIG. 2 is a screen shot of an interface used to interactively create projects according to one embodiment of the present invention.

FIG. 3A is a screen shot of an interface showing an abbreviated status dashboard for a project according to one embodiment of the present invention,

FIG. 3B shows an other embodiment of a status dashboard for a project according to the present invention.

FIG. 4A is screen shot of an interface showing a status dashboard for a portfolio of projects according to one embodiment of the present invention.

FIG. 4B is an alternative embodiment of a status dashboard for a portfolio of projects.

FIG. 5A is a screen shot of an interface showing a PERT chart that includes buffer indicators and a status bar for each task in a project according to one embodiment of the present invention.

FIG. 5B is a screen shot of an interface showing a PERT chart that includes both feeding buffers and an overall project buffer.

FIG. 6 shows a screen display of a PERT chart for a portfolio of projects according to one embodiment of the present invention.

FIG. 7 shows a screen shot of another embodiment of a status dashboard for a project according to the present invention.

FIG. 8 is a screen shot of another embodiment of a portfolio dashboard according to the present invention.

FIG. 9 shows another embodiment of a project PERT chart according to the present invention.

FIG. 10 shows a screen shot of a dynamic drum chart according to one embodiment of the present invention.

FIG. 11 shows a PERT chart used to illustrate calculation of a risk quotient according to one feature of the present invention.

### DETAILED DESCRIPTION OF THE PREFERRED EMBODIMENT

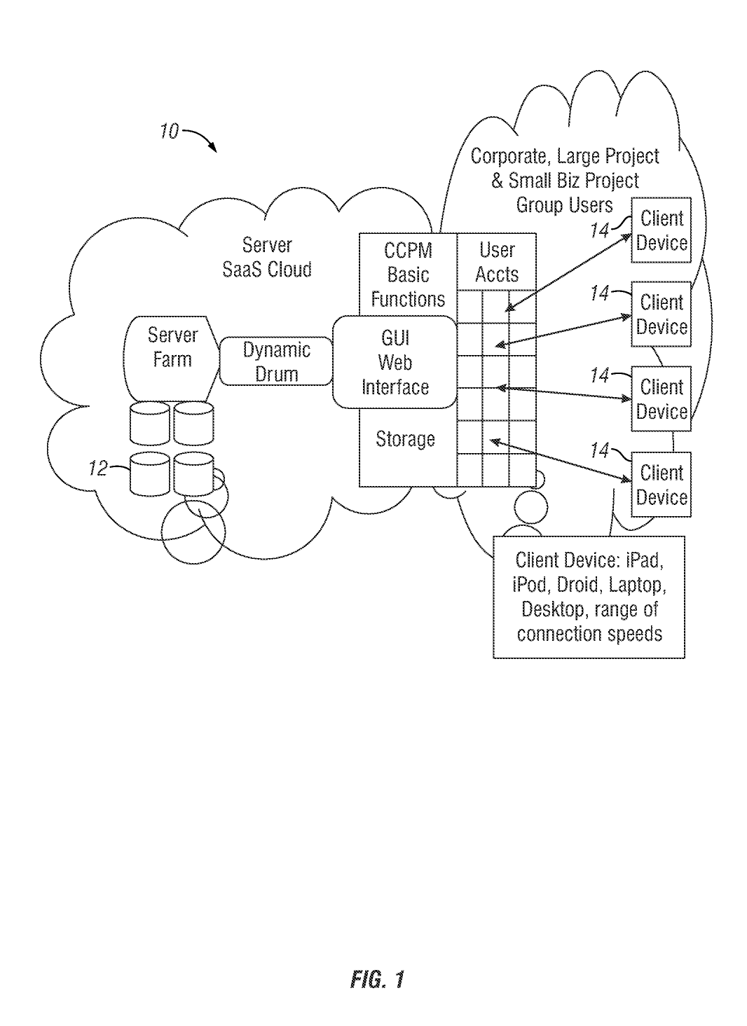

FIG. 1 is a schematic showing a project management system 10 according to one embodiment of the present invention. A host device 12, typically a server, or multiple servers, is programmed to perform operations that are helpful in managing projects. Multiple users, typically project managers or team members, can access the host device 12 using client devices 14. The client devices 14 may include such devices as desk top or lap top computers, personal digital assistances (PDAs), tablet computers (e.g., iPad), smart phones, cellular phones, and the like. According to a feature of the present invention, the vast majority of the computing power and memory required to run the software is contained on the host device 12. The requirements for the client devices 14 are minimal. In other words, the system 10 is heavy at the back end and light at the user end. The host device 12 might be rented or owned servers that provide access to numerous users from various entities. The host device 12 could be part of a “cloud” type network of servers. The users may be assigned passwords, or other security features may be used, to limit access to authorized users.

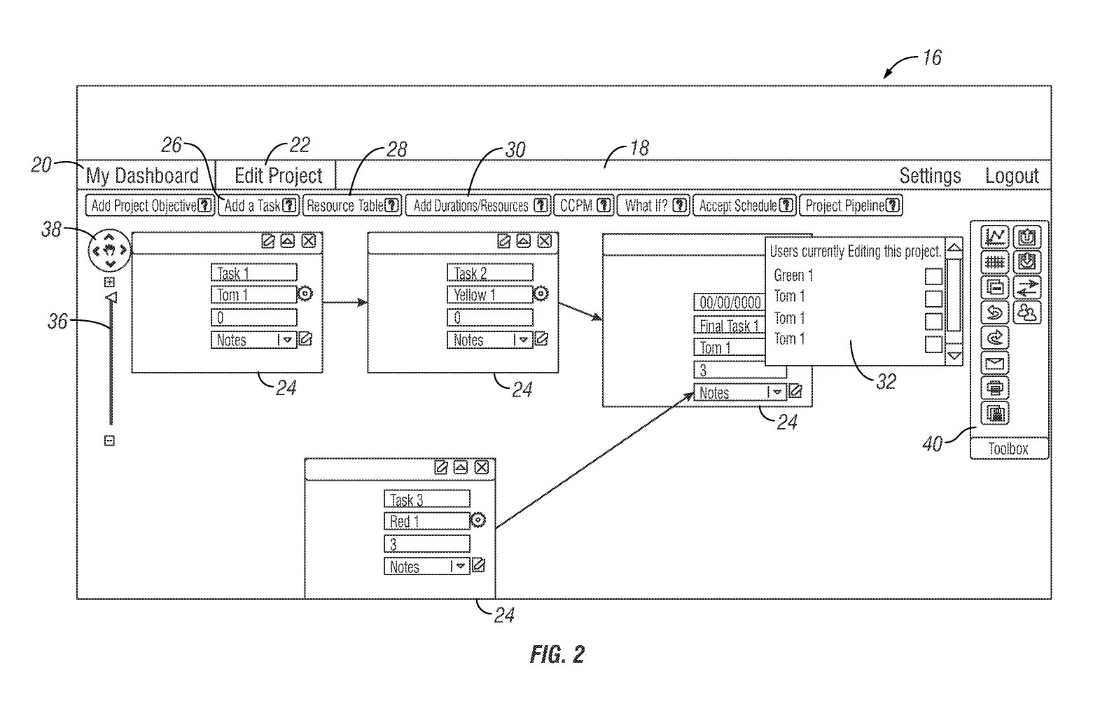

FIG. 2 shows a partial screen shot of project editing screen 16 according to one feature of the present invention. The project editing screen 16 would appear on at least one of the user device 14 (see FIG. 1). Preferably the same editing screen 16 could be simultaneously accessed and modified by several users. The project editing screen 16 is used as the primary interface to create and edit a project. Each of the projects can be organized and included within a portfolio of projects that might be associated with each user. At the top of the screen is a primary function bar 18 with a My Dashboard tab 20 and an Edit Project tab 22. The project editing screen 16 is accessed by selecting the Edit Project tab 22. A project comprises a plurality of related tasks. Each of the tasks is represented by a task box 24. Each task box 24 includes fields that a user fills with information about the task. For example each task box 24 may include fields for a title or task name, for resources that will be utilized in performing the task, for a duration expected to accomplish the task, and additional notes or information about the task or links to other stored documents. Preferably the resources field may be filled by a user selecting a resource or resources from a drop down menu loaded with a selection of possible resources. Therefore, to create a task within a project, a user selects the add a task tab 26 and then fills in the relevant field within the task box 24. For example a user gives the task a name in the task field, then selects the resources that will be used in the task, then fills in an expected duration for the task and adds any note or additional information about the task. A user may see a list of available resources by clicking the Resources Table tab 28. Additional resources may be added clicking the Add Resources tab 30.

According to one feature of the project editing screen 16 of FIG. 2, multiple users may access and edit the same project simultaneously. This permits valuable collaboration in creating projects. Preferably, but not necessarily, the users may also be connected to each other via a voice over internet protocol so that they can speak to each other as the create and. edit the projects. A current users box 32 shows which users are currently editing the project. Any of the current users can create and fill-in a task box, or add content to a task box created by another user. Each of the users may be assigned a color code, and the task boxes 24 may be color coded to match the assigned color code of the user that is currently editing the task, so that other users can see who is editing what tasks.

The task boxes 24 can be graphically moved by clicking and dragging the task boxes 24. Arrow connectors 34 are used to graphically indicate the order and dependency of the various tasks. To create a dependency, a user clicks on a portion of a task box 24 of a first task and then pulls the cursor to the task box 24 of a task that must necessarily follow that first task. An arrow connector 34 is thereby created that shows the interdependence of the two tasks and the order in which they must be completed, Each task must be connected to at least one other task in the project.

The project editing screen 16 may be provided with a size adjustment control 36. This adjust the magnification of the screen 16 so that users can zoom in for a better view of the individual boxes 24, or zoom out when there are numerous boxes to get a view of a greater portion of the entire project. A slider control is shown, but other types of size adjustment controls could be used. Similarly, a navigation tool 38 is provided to permit users to move the portion of the field visible in the screen 16. The navigation tool may be a drag and drop tool as will be familiar to most users. Other standard tools may be provided on a tool bar 40.

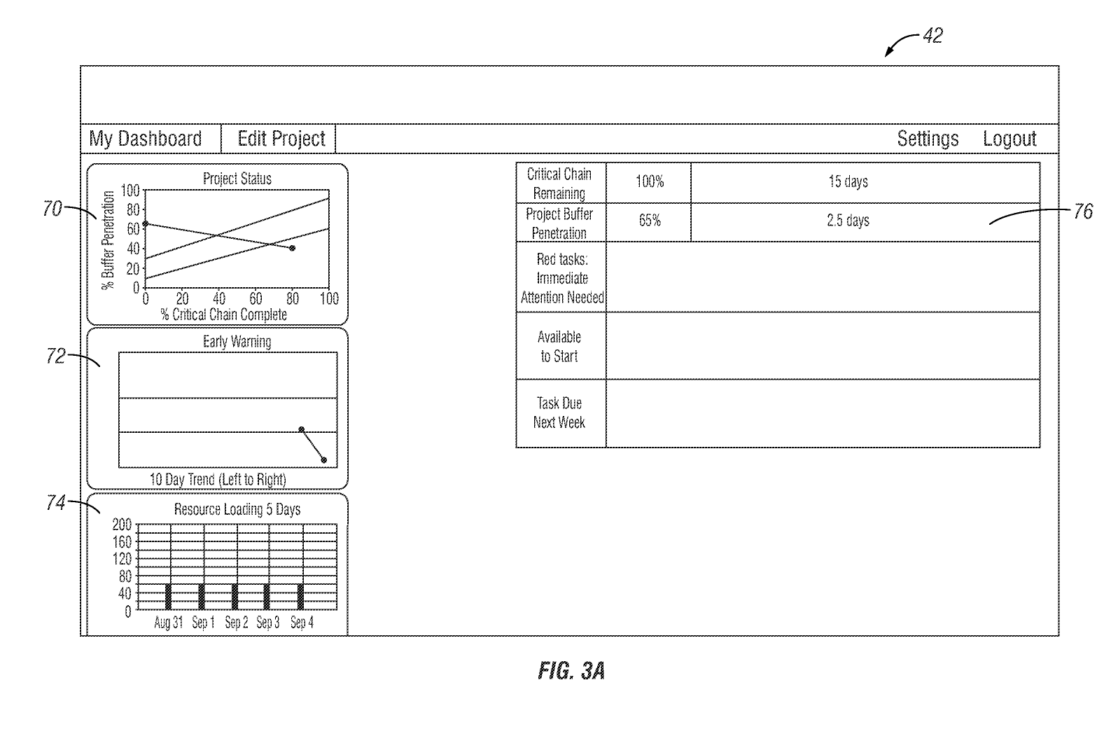

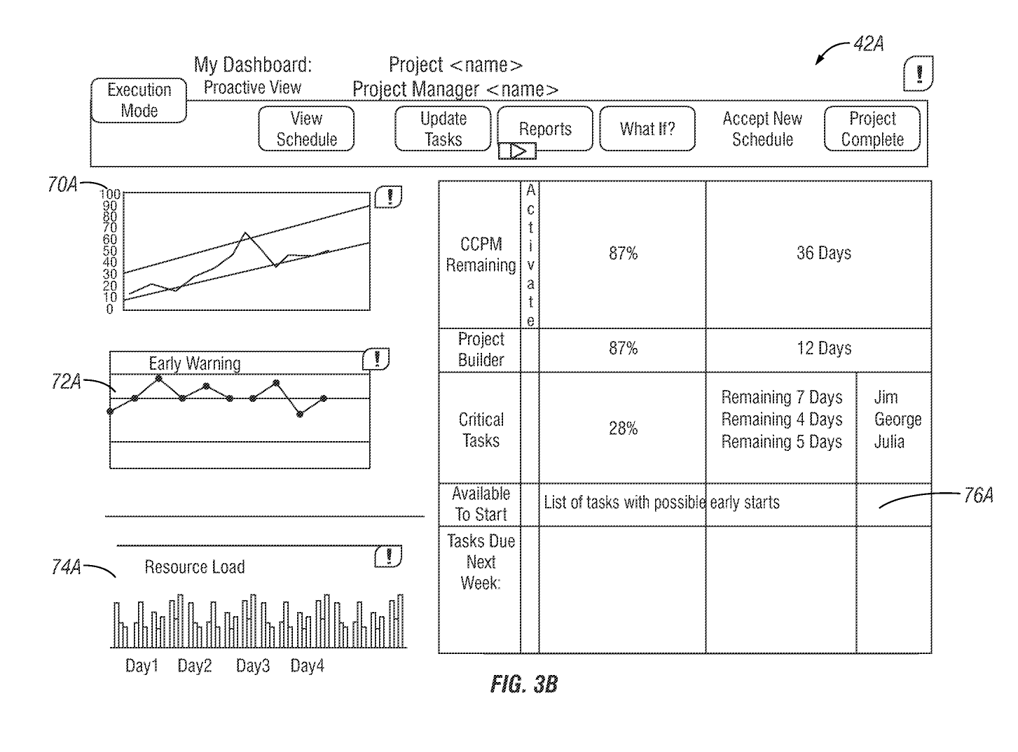

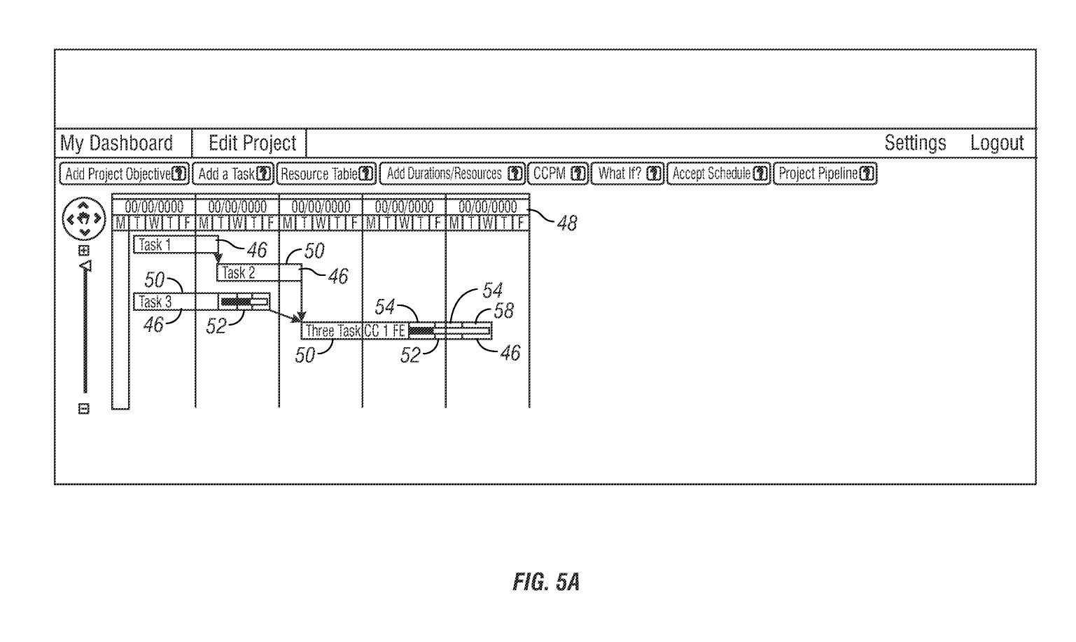

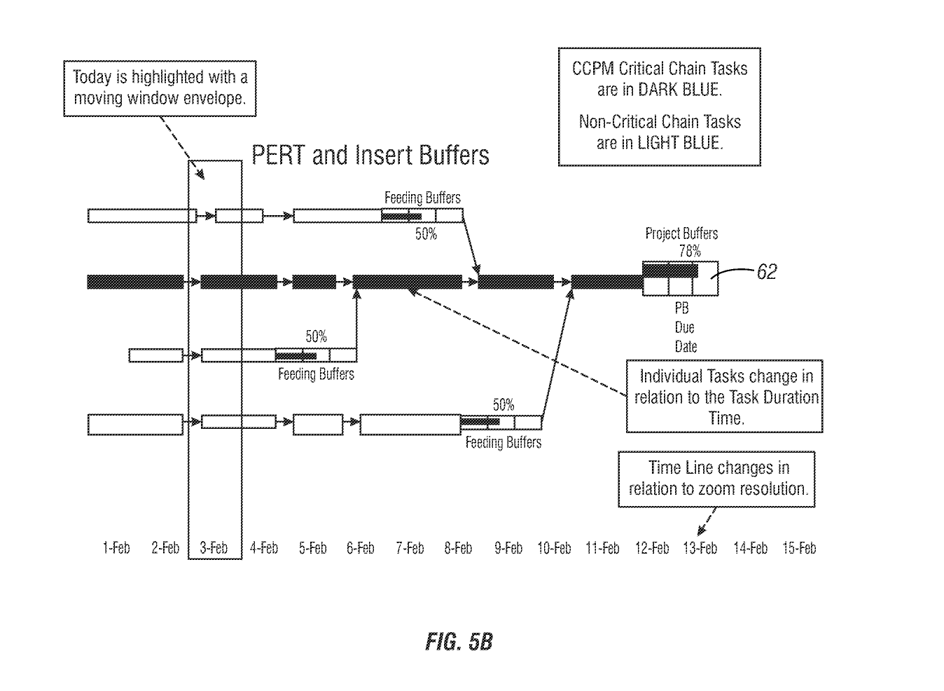

After the project management system 10 has been used to create projects using the project editing screen 16, the projects are stored on the provider device 12. A group of related projects, for example all projects belonging to one user, may be grouped as a portfolio of projects. As will be described in more detail in relation to FIGS. 5A & B and 6, the present invention applies an algorithm for organizing and prioritizing tasks within the various projects of a portfolio. Additionally, as described below with regards to FIGS. 3-5, the present invention provides several displays that can be helpful for organizing and informing project manager and team members of the status of projects within a portfolio.

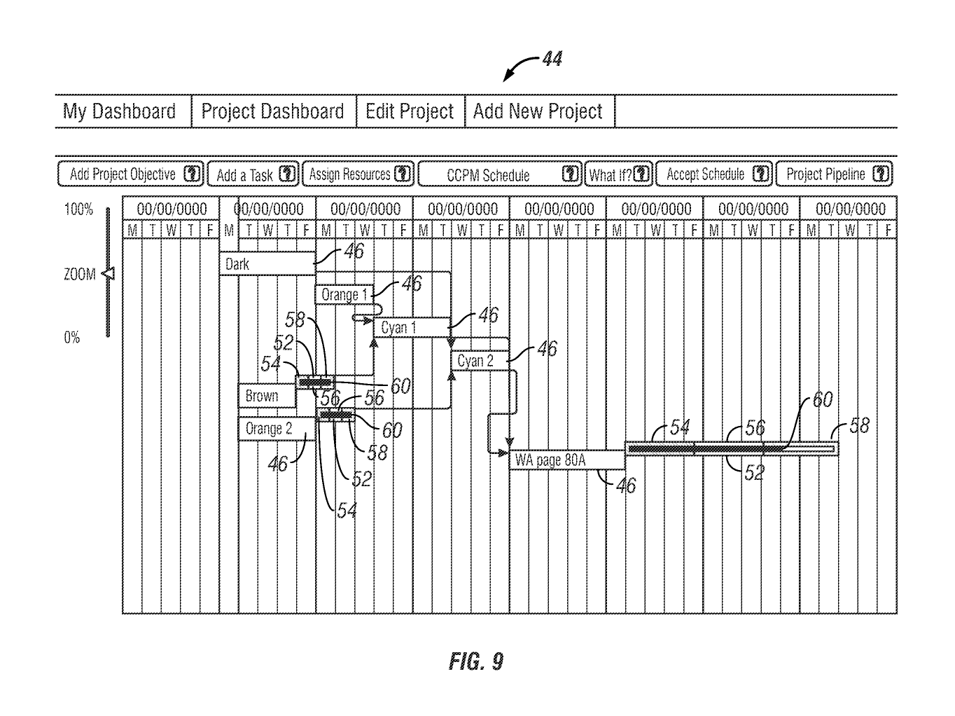

For each project created using the tool of FIG. 2, a PERT chart 44 can be created as shown in FIGS. 5A, 5B, and 9. As seen in FIG. 5A, the PERT chart 44 includes individual task bars 46. A timeline 48 is provided in a horizontal orientation to indicate expected dates for various tasks. The task bars 46 each include a primary portion 50 that corresponds with the expected time for that task. The task bars 46 also include a buffer portion 52 that corresponds with the excess time that could be spent on a task beyond the expected. time without delaying the overall project. The primary portion 50 may be color coded. For example, the critical chain tasks—those tasks that drive the timely completion of the project—may be shown in a highlighted or different color than the other tasks. The task bars 46 may also change color to indicate that they are complete. Once a task is complete the buffer portion 52 may no longer be removed from the display.

The buffer portions 52 provide a quick indication of how much of the buffer time has been used for a given task, or set of preceding tasks. Each buffer portion is divided into three sections, a safe section 54, a concern section 56, and a critical section 58. These sections may be color coded. An indicator bar 60 is provided within the buffer portion 52 to indicate how much of the buffer has been used. If the buffer indicator reaches the critical section 58, a user knows that that task is at risk for delaying the completion of the project. Therefore the present invention provides a PERT chart for a project with an incorporated indication of how much of the buffer has been used on the individual tasks. FIG. 9 shows another embodiment of the project PERT chart shown FIG. 5A. The PERT chart 44 includes individual task bars 46. A timeline 48 is provided in a horizontal orientation to indicate expected dates for various tasks. The task bars 46 each include a primary portion 50 that corresponds with the expected time for that task. The task bars 46 also include a buffer portion 52 that corresponds with the excess time that could be spent on a task beyond the expected time without delaying the overall project. The primary portion 50 may be color coded. For example, the critical chain tasks—those tasks that drive the timely completion of the project—may be shown in a highlighted or different color than the other tasks. The task bars 46 may also change color to indicate that they are complete. Once a task is complete the buffer portion 52 may no longer be removed from the display.

The buffer portions 52 provide a quick indication of how much of the buffer time has been used for a given task, or set of preceding tasks. Each buffer portion is divided into three sections, a safe section 54, a concern section 56, and a critical section 58. These sections may be color coded. An indicator bar 60 is provided within the buffer portion 52 to indicate how much of the buffer has been used, If the buffer indicator reaches the critical section 58, a user knows that that task is at risk for delaying the completion of the project. Therefore the present invention provides a PERT chart for a project with an incorporated indication of how much of the buffer has been used on the individual tasks.

FIG. 5B shows another embodiment of the same feature as FIG. 5A. In FIG. 5B, in addition to the individual buffer portions an overall project buffer portion 62 displays the overall total buffer from each of the tasks that has been utilized.

The charts of FIGS. 5A, 5B, and 9 show the cause and effect relationship of work content and assigned resources required to execute a series of tasks to achieve an agreed to objective. The critical chain, which is the longest chain of tasks and resources, is graphically indicated by highlighting the critical path. The buffers provide protection against falling behind schedule, and are inserted at the highest risk areas. The buffers are inserted to schedule specific tasks to commence at an earlier time. Therefore, as a user alters parameters of a project using the project editing screen of FIG. 2, they can visualize how those changes affect the progress of the project.

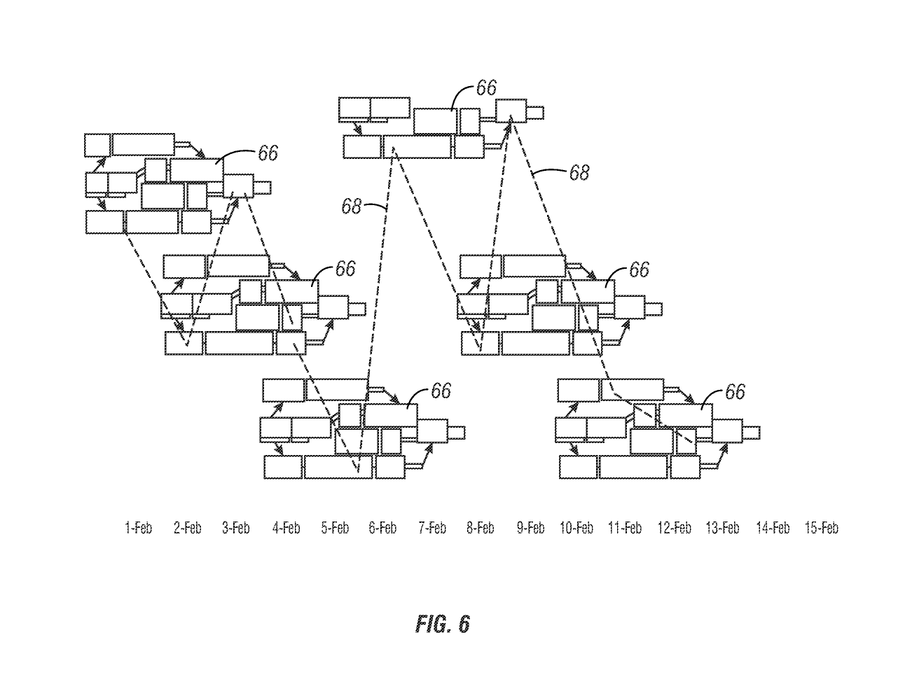

FIG. 6 shows a screen display of a PERT chart 64 for a portfolio of projects. Each of the projects 66 is shown as a cluster of tasks. All of the projects are arranged on a timeline. The projects 66 are staggered to appropriately use the resources in order to efficiently complete the entire portfolio of projects. The staggering is based on a pacing resource (also referred to as the “dynamic drum” resource). Dotted lines 68 connect the pacing resources in each project so that a user can visualize how changes in the drum resource might affect the overall portfolio of projects. As new projects within the portfolio are initiated the dynamic drum resource may change. In prior art solutions the pacing resource is automatically selected as the most loaded resource. The PERT chart 64 of FIG. 6 would work with this standard method of using the most loaded resource as the drum resource. However, as described in more detail below it is preferred to use an improved method for selecting the dynamic drum resource.

In order to properly stagger the projects 66 a preferred algorithm is used to select the drum resources. After all of the tasks for the various projects in a portfolio have been created using the tool of FIG. 2, the host device 12 (see FIG. 1) determines the dynamic drum resource for each project. Each project is independently scheduled using aggressive durations (duration time and safety removed) and without buffers. A user then selects what projects to include within a portfolio. Each resource used in the portfolio is analyzed to determine what percentage is used over of the entire portfolio of projects. Any resource that is at X% (e.g., 90%) or greater utilization cannot be considered the dynamic drum resource. Resources that are used in at least Y% less y% (e.g., 90%−10%) of the projects are considered as possible dynamic drum resources. If no resources are used in Y% less y% of the projects, then the host device 12 looks for resources that are used in Y% less 2y% (e.g., 80%). This process is repeated at y% increments until possible dynamic drum resources are identified. Out of these possible dynamic drum resources, the host device 12 creates a subset of resources that are used over greater than Z% (e.g., 5%) of each project's duration. If no resources are selected for the subset then the duration is decreased by (Z/10)% increments (e.g., 0.5% increments) and repeated, until resources are found that meet the minimum use percentage and the minimum duration percentage. The user then selects the order in which the projects are preferred to be conducted, The host device 12 considers the projects to be conducted sequentially with no overlap.

Then for each resource in the subset, overlap the projects in the portfolio only so much that the end of the last task that uses the potential drum resource matches in time the start of the first task of the next project. After making this assumption, calculate and store the total duration of the portfolio of projects. The host device then calculates the standard deviation of the maximum resource utilization throughout the entire duration of the portfolio of projects. This is a standard deviation for the durations of each resource across all of the projects in the portfolio. This ensures that the selected drum resource is relatively stable and predictable. The recommended drum resource is tentatively selected as the resource that gives the shortest duration for the portfolio of projects, provided that it also has a standard deviation for the maximum resource utilization of less than a selected or adjustable standard deviation (e.g., 1.5 days). A user may select the recommended dynamic drum resource, or may select another resource (non-dynamic drum) as the drum resource.

The timing of the projects within a portfolio for a selected dynamic drum resource is determined by adding P% (e.g., 20%) of the sum of the total duration times for the last project execution and scheduling the planned start for the next project in the portfolio to commence at that time. These steps should be repeated anytime a project is added, completed or modified. This helps a user in selecting the appropriate dynamic drum resource.

FIGS. 3A and 3B show screen shots of project status dashboards. The project status dashboards permit a user to quickly see the current status and history of a particular project. FIG. 3A shows an abbreviated project dashboard 42. The project dashboard 42 includes a project status chart 70, an early warning chart 72, a resource loading chart 74, and a project summary table 76. A user can quickly review the status of a project by viewing the status dashboard 42. The project status chart includes three color-coded fields to indicate the status of the project as on target, at risk, or critical. The x-axis is the percentage of the critical chain that has been completed, and the y-axis is the percentage of the project buffer that has been penetrated. A project can be plotted on the chart 70 based on its percentage of critical chain completed and its percentage of project buffer penetrated. The progress of a project can be seen by plotting the status of the project at various percentages of the percentage of the critical chain completed,

The early warning chart 72 includes three categories that generally correspond to how at risk a project is for getting off schedule. Those of skill in the art will be aware of various mechanisms for making this determination. The risk status of a project may be indicated as a point on the char 72 within one of the risk categories. The status at various times may be indicated to show how the project is trending with respect to risk for getting off schedule.

The resource loading chart 74 is a bar graph that shows the relative total resource load at various times. This cart 74 quickly gives a visual indication of how great a load the project is putting on resources, and how that load is trending.

The project summary chart 76 provides information about the project including the critical chain remaining—both as percentage of total and as absolute number of days, the buffer penetration—both as a percentage of total and as absolute number of days, the tasks that need immediate attention, tasks that are available to be started, and tasks that are due in the near future.

An alternative project dashboard 42A is shown in FIG. 3B. The project dashboard 42A includes a project status chart 70A, an early warning chart 72A, a resource loading chart 74A, and a project summary table 76A. A user can quickly review the status of a project by viewing the status dashboard 42. The project status chart includes three color-coded fields to indicate the status of the project as on target, at risk, or critical. The x-axis is the percentage of the critical chain that has been completed, and the y-axis is the percentage of the project buffer that has been penetrated. A project can be plotted on the chart 70A based on its percentage of critical chain completed and its percentage of project buffer penetrated. The progress of a project can be seen by plotting the status of the project at various percentages of the percentage of the critical chain completed.

The early warning chart 72A is a graphic for showing show at risk a project is for getting off schedule. Those of skill in the art will be aware of various mechanisms for making this determination. The risk status of a project may be indicated as a point on the chart 72A to show a relative risk level. The status at various times may be indicated to show how the project is trending with respect to risk for getting off schedule.

The resource loading chart 74A is a bar graph that shows the relative total resource load at various times. This cart 74A quickly gives a visual indication of how great a load the project is putting on resources, and how that load is trending. Several resources can be shown on the chart 74A, with each resource assigned a color code.

The project summary chart 76A provides information about the project including the critical chain remaining—both as percentage of total and as absolute number of days. the project buffer penetration—both as a percentage of total and as absolute number of days, the tasks that need immediate attention, tasks that are available to be started, and tasks that are due in the near future.

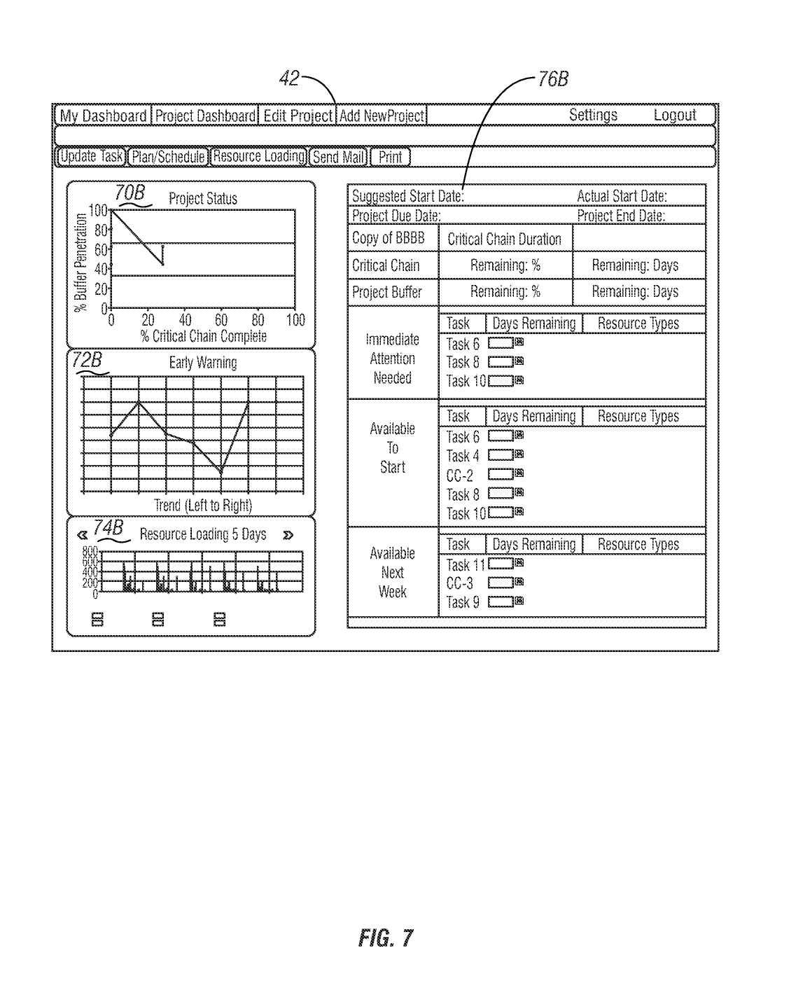

FIG. 7 shows another embodiment of a project summary dashboard 42B that is similar to the chart 42A shown in FIG. 3B. The project dashboard 42B includes a project status chart 70B, an early warning chart 72B, a resource loading chart 74B, and a project summary table 76B. A user can quickly review the status of a project by viewing the status dashboard 42B. The project status chart includes three color-coded fields to indicate the status of the project as on target, at risk, or critical. The x-axis is the percentage of the critical chain that has been completed, and the y-axis is the percentage of the project buffer that has been penetrated. A project can be plotted on the chart 70B based on its percentage of critical chain completed and its percentage of project buffer penetrated. The progress of a project can be seen by plotting the status of the project at various percentages of the percentage of the critical chain completed.

The early warning chart 72B is a graphic for showing show at risk a project is for getting off schedule. Those of skill in the art will be aware of various mechanisms for making this determination. According to one embodiment of the invention described in more detail below, a risk quotient may be calculated to determine risk status. The risk status of a project may be indicated as a point on the chart 72A to show a relative risk level. The status at various times may be indicated to show how the project is trending with respect to risk for getting off schedule.

The resource loading chart 74B is a bar graph that shows the relative total resource load at various times. This cart 74B quickly gives a visual indication of how great a load the project is putting on resources, and how that load is trending. Several resources can be shown on the chart 74B, with each resource assigned a color code.

The project summary chart 76A provides information about the project including the critical chain remaining—both as percentage of total arid as absolute number of days, the project buffer penetration—both as a percentage of total and as absolute number of days, the tasks that need immediate attention, tasks that are available to be started, and tasks that are due in the near future.

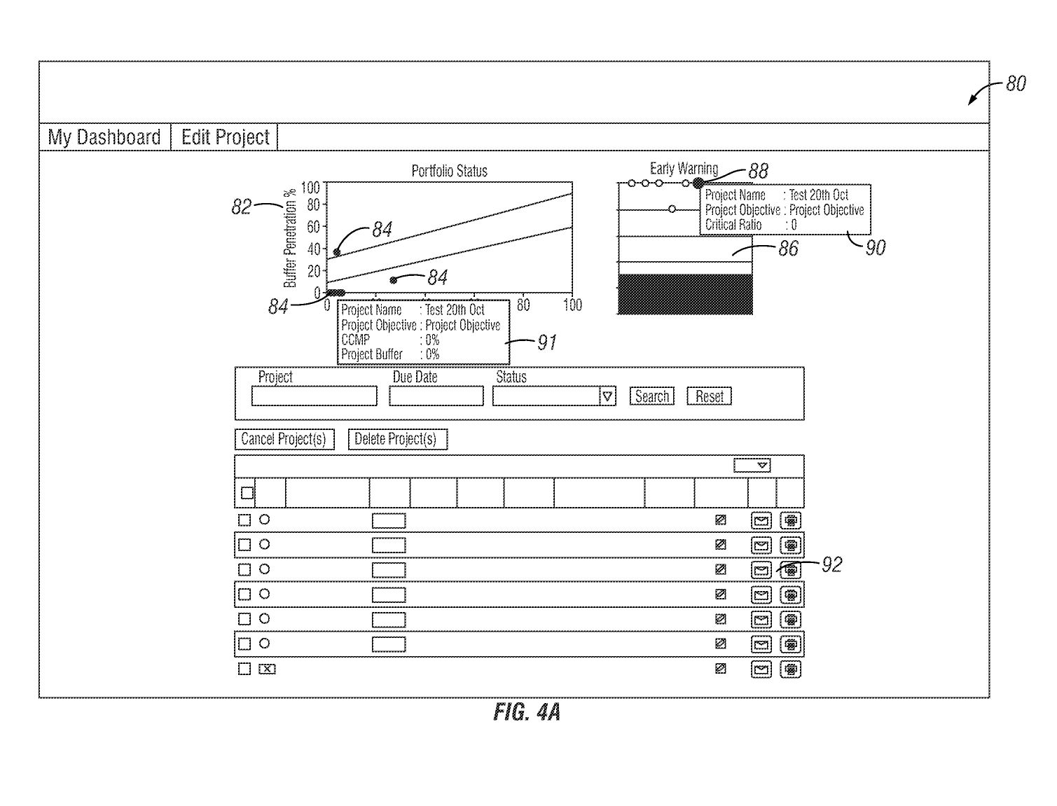

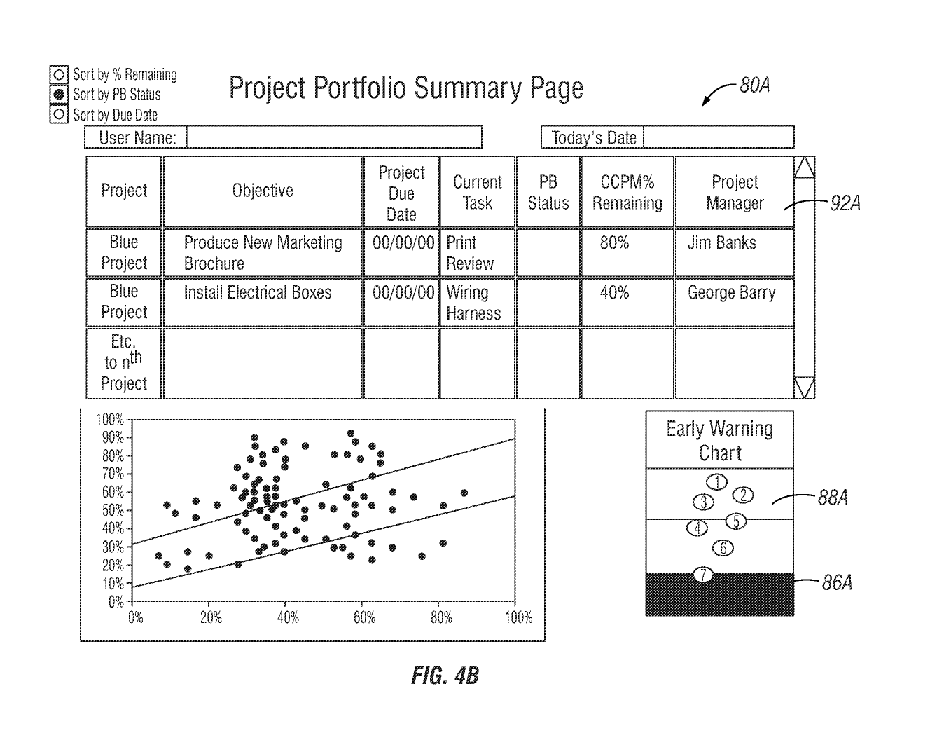

FIGS. 4A and 4B show portfolio status dashboards 80 & 80A according to the present invention. The status dashboards 80 and 80A permit a user to quickly see the current status of a portfolio of projects. In FIG. 4A, the status dashboard 80 includes a portfolio status graph 82 that includes dots 84 representing the warning status of each of the projects in a portfolio. According to one feature of the present invention, a user can hover their curser over a dot 84 in the portfolio status graph 82 and an identifier popup window 91 will appear with the name of the project, plus a corresponding popup appears on the early warning graph 86. The early warning graph 86 similarly includes dots 88 representing each of the projects. Hovering a cursor over a dot 88 also causes a pop-up window 90 to appear in both the early warning graph 86 and the status graph 82. A listing of the projects in the portfolio is provided in a projects table 92. The projects table 92 includes detailed information about each of the projects. Highlighting one of the projects in the projects table 92 will cause the pop-up windows 90 and 91 corresponding to that project to appear in the status graph 82 and early warning graph 86. Double clicking on a project listing in the project table 92 will cause the display to display the project dashboard (see FIGS. 3A and 3B) corresponding with that project.

In FIG. 4B, the status dashboard 80A includes a portfolio status graph 82A that includes dots 84A representing the warning status of each of the projects in a portfolio. According to one feature of the present invention, a user can hover their curser over a dot 84 in the portfolio status graph 82A and an identifier popup window (not shown) will appear with the name of the project, plus a corresponding popup appears on the early warning graph 86A. The early warning graph 86A similarly includes dots 88A representing each of the projects. Hovering a cursor over a dot 88A also causes a pop-up window (not shown) to appear in both the early warning graph 86A and the status graph 82A. A listing of the projects in the portfolio is provided in a projects table 92A. The projects table 92A includes detailed information about each of the projects. Highlighting one of the projects in the projects table 92 will cause the pop-up windows corresponding to that project to appear in the status graph 82A and early warning graph 86A. Double clicking on a project listing in the project table 92A will cause the display to display the project dashboard (see FIGS. 3A and 3B) corresponding with that project.

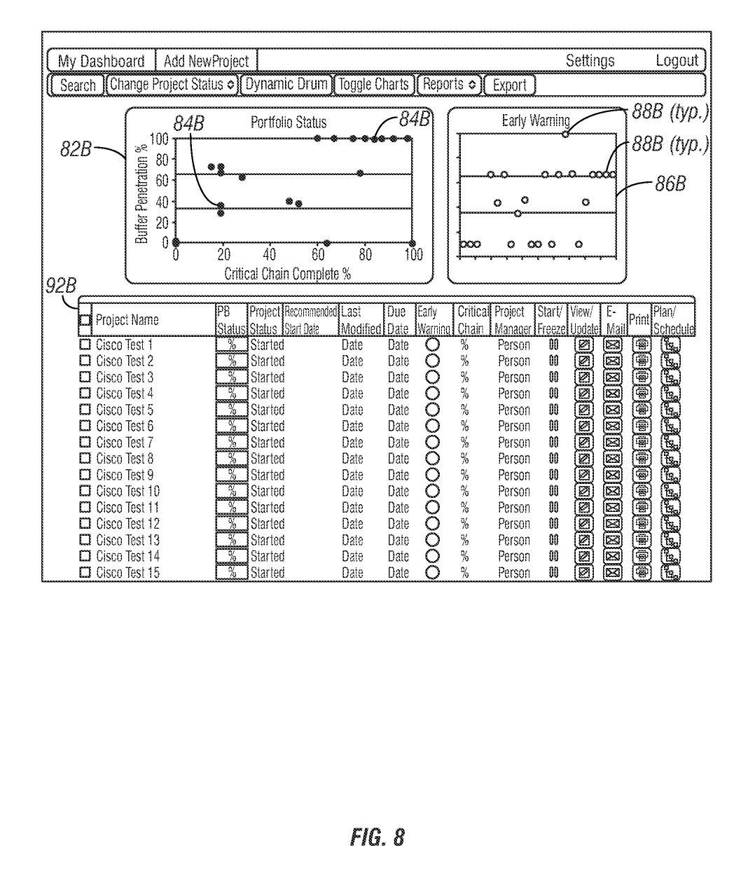

FIG. 8 shows another embodiment of a portfolio dashboard 80B according to the present invention. The status dashboard 80B includes a portfolio status graph 82B that includes dots 84B representing the warning status of each of the projects in a portfolio. The early warning graph 86B similarly includes dots 88B representing each of the projects. Hovering a cursor over a dot 88B also causes a pop-up window (not shown) to appear in both the early warning graph 86B and the status graph 82B. A listing of the projects in the portfolio is provided in a projects table 92B. The projects table 92B includes detailed information about each of the projects. Highlighting one of the projects in the projects talk 92B will cause the pop-up windows corresponding to that project to appear in the status graph 82B and early warning graph 86B. Double clicking on a project listing in the project table 92B will cause the display to display the project dashboard (see FIG. 7) corresponding with that project.

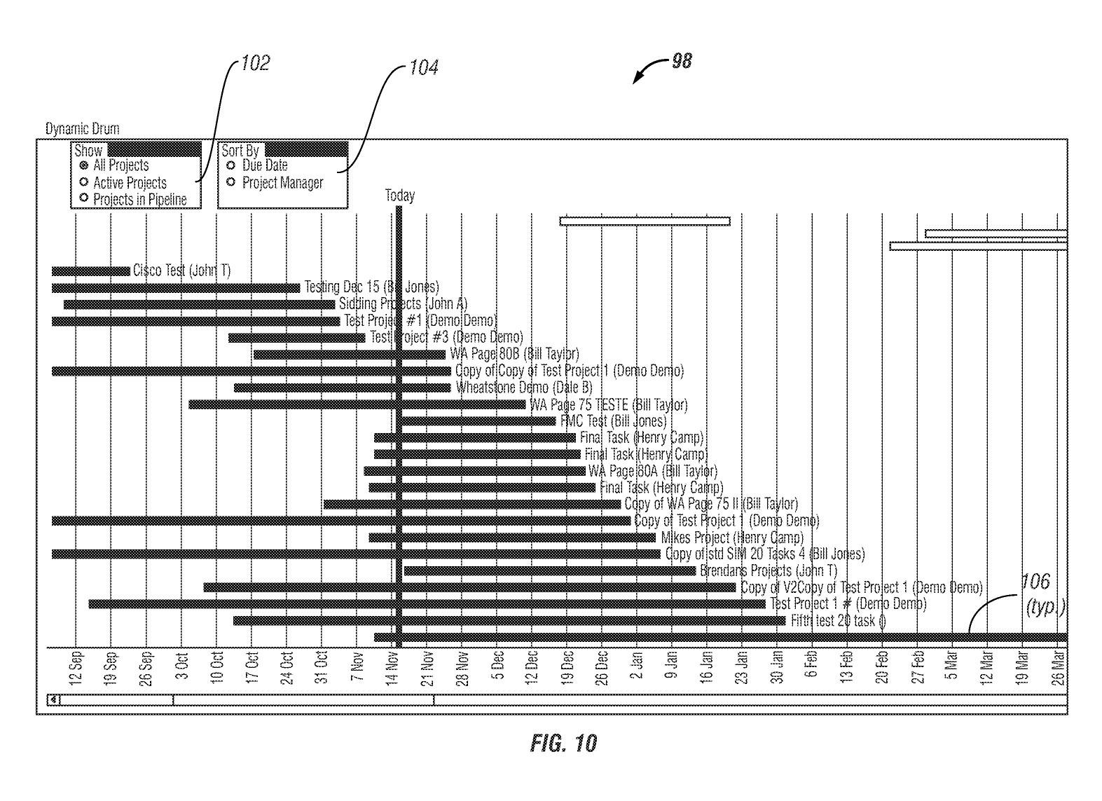

FIG. 10 shows a screen shot of a dynamic drum chart 98 according to one embodiment of the present invention. The chart 98 is presented with a timeline of dates presented on a horizontal axis. Bars 106 representing various projects are shown on the chart 98 aligned with their expected start and stop dates. The particular projects shown may be selected using the projects selection buttons 102. So a user may show all projects in the portfolio, only the active projects, or only the projects in the pipeline. The projects may be sorted by due date or by project manager according to selection buttons 104. The projects may be color coded to reflect their risk status.

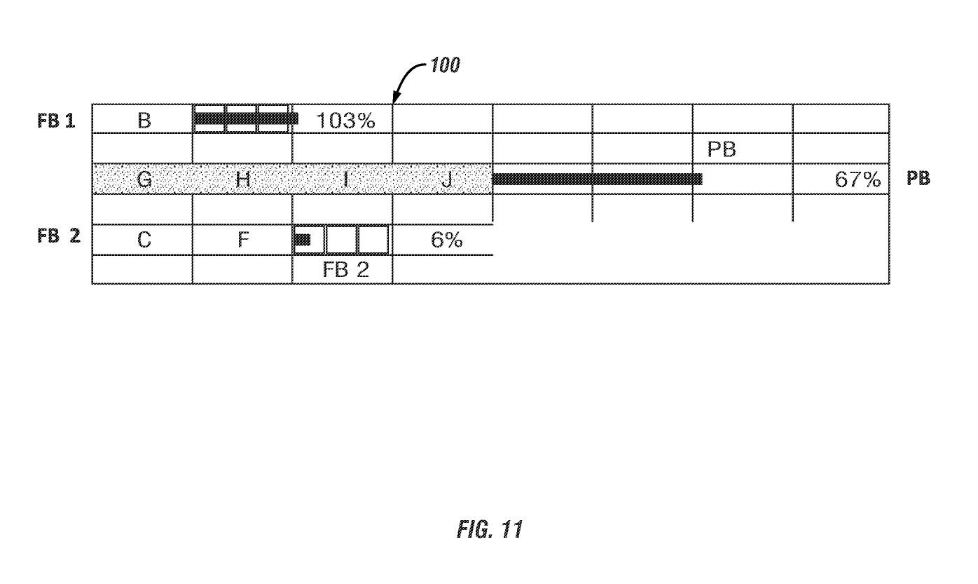

According to another embodiment of the present invention, the project management system 10 can be used to calculate and display a project risk quotient. The project risk quotient is measure of the overall project risk based on the buffer conditions. This helps a user to better gauge how at risk a project is for not being timely completed. The risk quotient can be used in the above embodiments that indicate a risk status. A higher risk quotient means the project is more likely at risk for not being completed in time. The project buffer is given a higher weighting of risk than the feeding buffers. FIG. 11 shows a PERT chart 100 for a project. As shown in FIG. 11, the project has two feeding buffers (FB), wherein the first feeding buffer (FB1) has been used to a percentage of 103% and the second feeding buffer (FB2) that has been 6% used up. Each of the feeding buffers is three days long. The project has a nine-day project buffer (PB) that is 67% utilized. To determine the risk quotient for the project, the following equation is used:

RQ=[Σ(FBₙpenetration %)×(FBₙDays)+(PB penetration %)×(PB days)×1.2]/(FBₙdays)+PB days)

The table below helps illustrate how the above equation is used to calculate a risk quotient of 70% for the project of FIG. 11.

TABLE 1
Illustration of calculation of Risk Quotient
for project shown in FIG. 11.

| | | Factor to | Weight |
|---|---|---|---|
| Project Risk Quotient | Days | further | the PB |

| | Penetration | Buffer Size | Weighting | Factor |
|---|---|---|---|---|
| FB 1 | 103% | 3 | 3.09 | 1 |
| FB 2 | 6% | 3 | 0.18 | 1 |
| PB | 67% | 9 | 6.03 | 1.2 |

| | | | |
|---|---|---|---|
| Total Buffer Days | 15 | 9.3 | 10.506 |
| Project Risk Quotient: | | | 70% |

A general description of the present invention as well as preferred embodiments of the present invention has been set forth above. Those skilled in the art to which the present invention pertains will recognize and be able to practice additional variations in the methods and systems described which fall within the teachings of this invention. Accordingly, all such modifications and additions are deemed to be within the scope of the invention, which is to be limited only by the claims appended hereto.

What is claimed:

1. A project management system comprising:
a remote server programmed to generate a graphic user interface that can be accessed by remote user devices;
the graphic user interface including: project and portfolio dashboards for quick status display, a portfolio and project status graphic that has a quick view of percentage completed and a status category of one or more projects; and a portfolio early warning graphic that provides a graphical indicator of whether projects are at risk for violating a critical chain.

2. A project management interface for creating projects within project management software, whereby several remote users can interact simultaneously within a single graphical user interface to create a project, the interface comprising:
a task creation field; and
dialog boxes that represent tasks and prompt input of necessary information to create tasks; the boxes being adapted to be graphically moved around on the task creation field.

3. The project management interface for creating projects within project management software according to claim 2, wherein dependencies between tasks can be created by graphically drawing arrows between the task boxes.

4. The project management interface for creating projects within project management software according to claim 2, wherein the boxes are color coded.

5. The project management interface for creating projects within project management software according to claim 2, further comprising a contingent mode to show what would happen if a status of a task is changed.

6. The project management interface for creating projects within project management software according to claim 2, wherein a status bar is associated with each task box.

7. A computer system that is programmed to determine a dynamic drum resource, the computer system comprising:
a computer readable medium programmed to determine each of a plurality of resources loading across a portfolio of projects;
the computer readable medium further programmed such that any resource with a utilization of greater than a maximum utilization percentage cannot be selected as the dynamic drum resource;
the computer readable medium being further programmed to determine a first subset of the plurality of resources common to a preset percentage of the projects in the portfolio;
the computer readable medium being further programmed to determine a second subset of resources that is used over a duration greater than a specified minimum percentage duration of each project from the first subset;
the computer readable medium being further programmed to calculate for each of the resources in the second subset a total duration of the portfolio of projects if that resource is the dynamic drum resource;
the computer readable medium being further programmed to calculate and store a standard deviation of a maximum resource utilization throughout an entire duration of the portfolio of projects; and
the computer readable medium being further programmed to select as the dynamic drum resource the resource that had the shortest calculated total duration that also had a calculated standard deviation of less than 1.5.
